(19) United States
(12) Patent Application Publication
(10) Pub. No.: US 2009/0212131 A1
(43) Pub. Date: Aug. 27, 2009

(54) Fuel Injector and Method for Identifying Same

(76) Inventor: Michael Morath, Stegaurach (DE)

Correspondence Address: KENYON & KENYON LLP, ONE BROADWAY, NEW YORK, NY, 10004, US

(21) Appl. No.: 12/083,852

(22) PCT Filed: Sep. 29, 2006
(86) PCT No.: PCT/EP2006/066912

§ 371 Date: Mar. 10, 2009

(30) Foreign Application Priority Data
Oct. 21, 2005 (DE) 10 2005 050 567.8

(51) Int. Cl. B05B 15/00

(52) U.S. Cl. 239/289

(57) ABSTRACT

A fuel injector includes a solenoid, an armature, and an axially displaceable valve part which is enclosed by a plastic extrusion coat, an RFID chip being irreversibly attached to the plastic extrusion coat at an advantageous position. This RFID chip initially has no data content. During the production process specific data are written on the RFID chip, and later in the production process the specific data are read and evaluated by a writing and reading unit. Specific steps are carried out during the production process, based on the evaluated specific data.

### FIELD OF THE INVENTION

The present invention relates to a fuel injector that includes a solenoid, an armature, and an axially displaceable valve part which is enclosed by a plastic extrusion coat, and an RFID chip that is attached to the plastic extrusion coat at an advantageous position.

### BACKGROUND INFORMATION

There are methods that relate to a fuel injector on which data are written using a data matrix code. The data matrix code contains customer-relevant information which the customer may read, evaluate, and immediately use.

A disadvantage is that the storage capacity of the data matrix code attached to the fuel injector is small, so that only a limited, selective amount of customer-relevant information is able to be relayed to the customer.

### SUMMARY OF THE INVENTION

An object of the present invention, therefore, is to provide a fuel injector having a storage medium with a high storage capacity. The storage medium, which is to be reliably attached to the fuel injector, is designed to store data generated during production of the fuel injector as well as data essential for operating the fuel injector.

This object may be achieved according to the exemplary embodiments and/or exemplary methods of the present invention by use of a fuel injector having an RFID chip at a favorable position.

The fuel injector according to the present invention contains a microchip on which specific data may be written, the microchip attached to the fuel injector initially being provided on the fuel injector without data content. It is advantageous that the microchip is an RFID chip having a high storage capacity.

A further advantage of the fuel injector according to the present invention is that the RFID chip is irreversibly attached to the fuel injector, a favorable position for attachment being provided in the extrusion-coated plastic element in the injector housing. It is advantageous that great flexibility is provided in selecting the favorable position, since the relative positioning of the RFID chip need not be spatially aligned with a writing and reading unit; i.e., it is not necessary for the RFID chip and the writing and reading unit provided for same to be positioned in the immediate vicinity of one another.

The RFID chip advantageously includes a transmitter and a responder, which allows data to be written on and deleted from the RFID chip in a contactless manner via a suitable writing and reading unit.

In addition to the high storage capacity of the RFID chip attached to the fuel injector, the fuel injector according to the present invention has the advantage that the RFID technology may be implemented more economically than a data matrix code to be attached to a fuel injector.

Advantageous refinements and improvements of the fuel injector stated in claim 1 and of the method stated in claim 11 are made possible by the measures recited in the subclaims.

It is also advantageous that during use, the fuel injector according to the present invention may be unambiguously identified during the production process, since the RFID chip on which specific data may be written but which is initially provided without data content may be read before each production step, or may be further written on after each production step. As a result, it is advantageous that complicated linking of the manufacturing process may be omitted, thereby also reducing the quantity of rejects generated.

Installation defects may advantageously be avoided by individually writing on each produced fuel injector, since the individual data for the fuel injector may also be read by the customer before each particular step.

One exemplary embodiment of the present invention is illustrated in simplified form in the drawings and is explained in greater detail in the following description.

### BRIEF DESCRIPTION OF THE DRAWINGS

FIG. 1 shows a fuel injector according to the present invention.

FIG. 2 shows a schematic view of a fuel injector according to the present invention, together with a writing and reading unit.

FIG. 3 shows a schematic view of an RFID chip attached to the fuel injector according to the present invention.

FIG. 4 shows a diagram for the application of a fuel injector according to the present invention during the production process.

FIG. 5 shows a schematic view of a further application of a fuel injector according to the present invention in an automobile.

### DETAILED DESCRIPTION

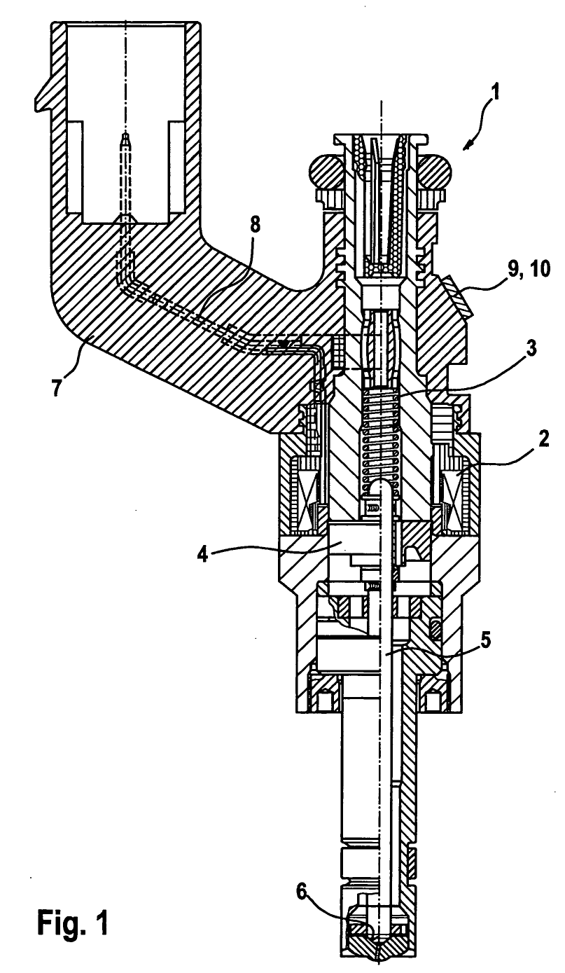

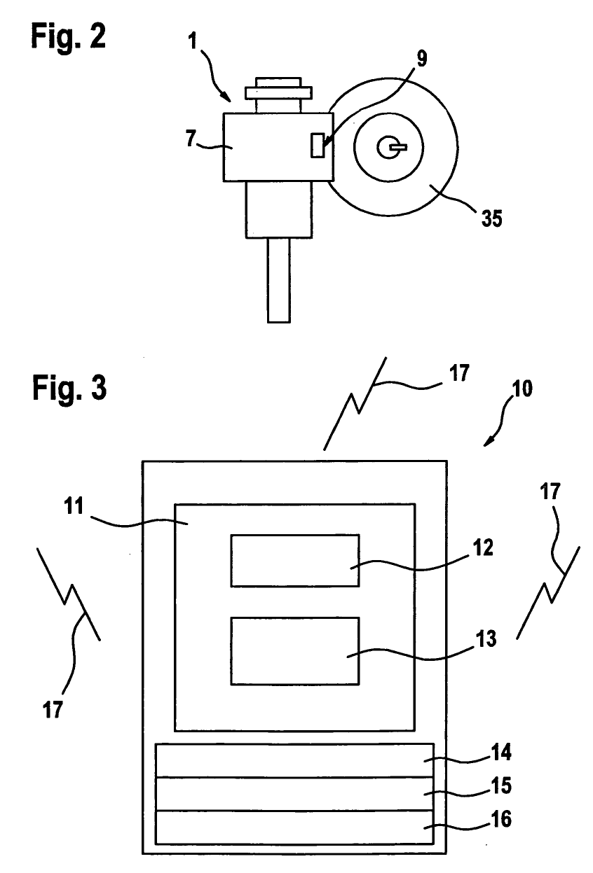

FIG. 1 shows a fuel injector 1 according to the exemplary embodiments and/or exemplary methods of the present invention including a solenoid 2 that cooperates with an armature 4 that is acted upon by a restoring spring 3. Together with a valve needle 5, armature 4 forms an axially displaceable valve part, a valve closing body 6 being provided on valve needle 5 and forming a sealing seat together with a valve seat body. Also provided on fuel injector 1 according to the exemplary embodiments and/or exemplary methods of the present invention is a plastic extrusion coat 7 which includes electrical connection 8. In an advantageous position of the plastic extrusion coat 7, a microchip 9 is irreversibly fixed in the form of an RFID chip 10 on which specific data may be written. RFID chip 10, which is fixed to the fuel injector according to the present invention, is initially without data content. During final production and the testing provided for quality assurance, RFID chip 10 is written on via a suitable writing and reading unit 35. A schematic view of the fuel injector according to the exemplary embodiments and/or exemplary methods of the present invention together with provided writing and reading unit 35 is shown in FIG. 2.

One possible favorable position, as shown in FIG. 2, for placement of RFID chip 10 is lateral to plastic extrusion coat 7, so that an axis of RFID chip 10 is aligned parallel to a longitudinal axis of fuel injector 1. Other positions in, at, or on plastic extrusion coat 7 are likewise advantageous, since the medium that is to be read no longer needs to have a defined configuration relative to a writing and reading unit 35 because the data transmission, as with the present Bluetooth technology, occurs via a spatially nonaligned radio channel 17, and therefore it is no longer necessary for microchip 9 or RFID chip 10 to be positioned in alignment relative to writing and reading unit 35.

FIG. 3 shows a schematic view of an RFID chip 10 which contains, among other elements, a transponder 11. Transponder 11 is a component having a transmitter 12 and a responder 13. Transmitter 12 contains a transmission function which transfers data from RFID chip 10 to provided writing and reading unit 35 via a spatially nonaligned radio channel 17. Overall, RFID chip 10 provides a functionality which includes electronic identification 14, contactless data transmission 15, and an on-call function 16. Electronic identification function 14 relates to storage of the specific data on RFID chip 10. Contactless data transmission function 15 proceeds from a spatially nonaligned radio channel 17 and achieves bidirectional data transfer of the specific data to RFID chip 10 or from RFID chip 10. On-call function 16 triggers contactless data transmission 15 of the specific data stored on RFID chip 10, the specific data to be transferred containing injector characteristics and/or production data and/or design data for fuel injectors 1.

The method according to the present invention for identifying fuel injectors 1 is directed to the attachment of RFID chip 10, on which specific data may be written, at a favorable position on corresponding fuel injector 1, RFID chip 10 initially being without data content. RFID chip 10 is irreversibly cast or glued onto plastic extrusion coat 7.

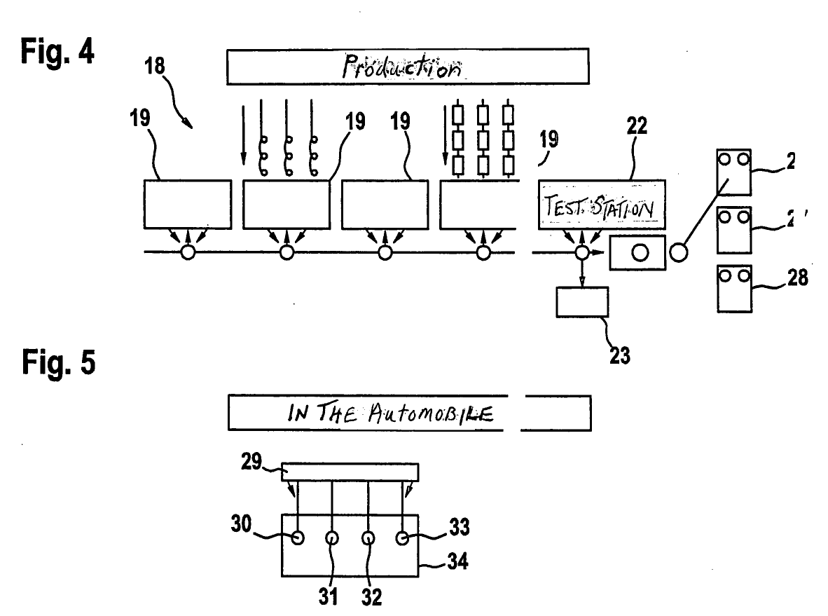

FIG. 4 shows a diagram of a production line 18 on which fuel injector 1 is assembled. Each station 19 assembles or tests fuel injector 1. At the start of production, RFID chip 10 is attached to fuel injector 1 at a favorable location. RFID chip 10 may also be supplied as an unwritten delivery part. Fuel injector 1 receives its identity in first station 19. Each subsequent station 19 checks the identity and is thus able to assemble and adjust fuel injector 1 on a model-specific basis. The results of the adjustment as well as the test results are stored on RFID chip 10 in particular station 19.

At the end of production line 18, a test station 22 is provided which tests the end product, i.e., fuel injector 1, in a targeted manner on the basis of the specific data transferred, in particular injector characteristics. If a test yields a negative result, negatively tested fuel injector 1 is sorted into a container 23 for rejects. Positively tested fuel injectors 1, i.e., fuel injectors 1 which meet the quality requirements, are sorted according to their identification, which is contained on RFID chip 10, into various packaging cartons 26, 27, 28.

FIG. 5 shows a diagram of a further application of a fuel injector 1 according to the present invention in an automobile. Four fuel injectors 30, 31, 32, and 33 are provided in an engine block 34. These four fuel injectors 30, 31, 32, and 33 are actuated by a common electronic control system 29. Also provided in this electronic control system 29 is a writing and reading unit 35 which reads the individual specific data for fuel injectors 30, 31, 32, and 33 to be actuated and transmits the data to a computing unit in electronic control system 29. This ensures that each individual fuel injector 30, 31, 32, and 33 is actuated according its individual injector characteristics.

RFID chip 10 may be glued to plastic extrusion coat 7 or may be cast with same.

The present invention is not limited to the illustrated exemplary embodiments and may also be used, for example, for fuel injectors which inject into an intake manifold which leads to a combustion chamber. the fuel injectors designed according to the present invention may be used in spark-ignition or compression-ignition internal combustion engines.

1-20. (canceled)

21. A fuel injector arrangement, comprising:
a fuel injector; and
a microchip on which specific data may be written, wherein the microchip, initially without data content, is provided at a specified position on the fuel injector.

22. The fuel injector arrangement of claim 21, wherein the microchip is irreversibly attached.

23. The fuel injector arrangement of claim 21, wherein a position of the plastic extrusion coat is the position for attaching the microchip.

24. The fuel injector arrangement of claim 21, wherein the microchip is an RFID chip.

25. The fuel injector arrangement of claim 24, wherein the RFID chip includes a transponder having a transmitter and a responder.

26. The fuel injector arrangement of claim 21, wherein a functionality of the RFID chip includes an electronic identification, a contactless data transmission, and an on-call function.

27. The fuel injector arrangement of claim 26, wherein the electronic identification includes a storage of the specific data on the RFID chip.

28. The fuel injector arrangement of claim 26, wherein the contactless data transmission proceeds from a radio channel and achieves bidirectional data transfer of the specific data from a writing and reading unit to the RFID chip or from the RFID chip to a writing and reading unit.

29. The fuel injector arrangement of claim 26, wherein the on-call function triggers the contactless data transmission of the specific data stored on the RFID chip.

30. The fuel injector arrangement of claim 21, wherein the specific data relate to at least one of injector characteristics, production data and design data for at least one fuel injector.

31. A method for identifying a fuel injector, the method comprising:
providing a fuel injector; and
attaching an RFID chip, on which specific data may be written, but which initially is provided without data content, to the fuel injector at a specific position on the fuel injector.

32. The method of claim 31, wherein the RFID chip is irreversibly attached.

33. The method of claim 31, wherein the RFID chip is attached to a plastic extrusion coat.

34. The method of claim 33, wherein the RFID chip is cast onto the plastic extrusion coat.

35. The method of claim 33, wherein the RFID chip is glued to the plastic extrusion coat.

36. The method of claim 31, wherein specific data are written on the RFID chip during a production process via a writing and reading unit.

37. The method of claim 36, wherein the specific data are generated during the production of the fuel injector and relate to at least one of injector characteristics, production data, and design data for at least one fuel injector.

38. The method of claim 37, wherein the RFID chip is read by the writing and reading unit during the production process.

39. The method of claim 38, wherein the specific data read from the RFID chip by the writing and reading unit are evaluated during the production process.

40. The method of claim 39, wherein specified operations for further use of the fuel injector are performed during the production process, based on the specific data which are read and evaluated from the RFID chip.
